(19) United States
(12) Patent Application Publication
(10) Pub. No.: US 2012/0114546 A1
(43) Pub. Date: May 10, 2012

(54) Hybrid TCS-siemens process equipped with 'turbo charger' FBR; method of saving electricity and equipment cost from TCS-siemens process polysilicon plants of capacity over 10,000 MT/YR

(76) Inventors: Yong Chee, Beverly Hills, CA (US); Tetsunori Kunimune, LaCanada, CA (US)

(21) Appl. No.: 13/200,989

(22) Filed: Oct. 6, 2011

Related U.S. Application Data
(62) Division of application No. 12/802,320, filed on Jun. 4, 2010.

(51) Int. Cl. C01B 33/027; B01J 8/26

(52) U.S. Cl. 423/349; 422/141

(57) ABSTRACT

A ‘hybrid’ TCS (Trichlorosilane)-Siemens process is provided to save electricity and initial investment cost from TCS synthesizing process and silicon tetrachloride to TCS converting process in a TCS-Siemens polysilicon plant, whose size is over 10,000 MT/YR of polysilicon. The ‘hybrid’ TCS-Siemens process of the current application is equipped with one direct chlorination FBR (Fluidized Bed Reactor) and one hydro-chlorination FBR. Three different TCS-Siemens processes are compared based on mass balance calculation. The hybrid TCS-Siemens process saves at least 78,000,000Kwhr/year of electricity from TCS generation only from a 10,000 MT/YR polysilicon plant when compared with a ‘Closed Loop TCS-Siemens Process’, which is equipped with only high-pressure, high-temperature operating hydro-chlorination FBRs.

Current application is a divisional application of the U.S. patent application Ser. No. 12/802,320 filed on Jun. 4, 2010.

### FIELD OF THE INVENTION

Current application relates to a method of saving electricity and equipment investment from a polysilicon plants, especially relates to plants which produce polysilicon using TCS in Siemens type CVD (Chemical Vapor Deposition) reactors.

### BACKGROUNDS OF THE INVENTION

Traditional TCS-Siemens process is a polysilicon producing process which is equipped with ‘thermal converter’ to convert STC from the CVD reactors into TCS and direct chlorination FBR for TCS generation. Later, a ‘closed loop’ hydro chlorination TCS-Siemens process is introduced. That process is equipped with a huge hydro chlorination FBR (Fluidized Bed Reactor) for TCS generation and STC conversion in the same reactor. Hybrid TCS-Siemens process, which is suggested in the current application, is equipped with a small direct chlorination FBR for TCS generation and a small hydro chlorination reactor for converting STC from CVD reactors to TCS. The traditional TCS-Siemens process has been proved as successful commercial polysilicon process for decades. However, since 2007, it is known to the industry that it consumes huge amount of electricity to convert STC to TCS. After that, hydro chlorination FBR, in which STC is converted to TCS by hydrogenation in the presence of MGSI (Metallurgical Grade Silicon), is asked by many customers who want plant size smaller than 5,000 MT/YR polisilicon. But, after 2011 many big Asian chemical companies announced to build polysilicon plants of production capacity over 10,000 MT/YR to take advantage of scale merit of the polysilicon plant. However, the ‘closed loop’ hydro chlorination process has limit in scale up due to its' inherent problem of generating two times of STC than TCS at the same time. For, 10,000 MT/YR polysilicon plant, the amount of STC recycling in the process is 800,000 MT/YR. Recycling the huge amount of STC costs more operation cost and equipment investment. It is purpose of the current application to provide an economical process to save electricity and equipment cost in a polysilicon plant of size over 10,000 MT/YR

### DESCRIPTION OF PRIOR ARTS

U.S. Pat. No. 2,943,918 to G. Paul, et al. illustrates a laboratory scale method of producing TCS (Trichlorosilane) by directly contacting HCL with MGSI (Metallurgical Grade Silicon) from a FBR (Fluidized Bed Reactor) and depositing polysilicon in a quartz tube after separating TCS and STC (Silicon Tetra Chloride).

U.S. Pat. No. 3,148,035 to E. Enk, et al. illustrates a method of generating TCS by direct chlorination of HCl in a bench scale FBR and the method of controlling exothermal heat of reaction. They also found that as the reaction temperature goes up, the amount of TCS generated decreases and the amount of STC increases.

U.S. Pat. No. 3,704,104 to M. S. Bawa, et al. illustrates an operation condition of FBR for maximum production of TCS by direct chlorination of MGSI. Dilution of HCl gas with nitrogen is suggested.

U.S. Pat. No. 4,044,109 to H. J. Kotzsch, et al. illustrates a method of increasing TCS production by direct chlorination of MGSI in a continuously operating FBR. They co-fed iron chloride to control the exothermal heat of the reaction.

U.S. Pat. No. 4,213,937 to Padovani, et al. illustrates a commercial scale polysilicon plant design. TCS was produced from a FBR by direct chlorination of MGSI. TCS was introduced a FBR for granular deposition of polysilicon.

U.S. Pat. No. 4,585,643 to T. H Baker Jr. illustrates a method of maximizing TCS production by direct chlorination of MGSI from FBR by intermediately injecting oxygen gas to the FBR during continuous operation.

U.S. Patent Application Publication No. 20100264362 by CHEE, et al. illustrates a method of controlling fluidized bed temperature in a FBR, wherein direct chlorination occurs, within a temperature deviation of ±1° C. at reaction temperature of 350° C.

Investor Relation Book issued by Hankook Silicon disclosed that their commercial FBR built by the application's description, under contract, produces crude TCS from the FBR of 95% purity at 5 bar and 300° C.

U.S. Pat. No. 2,406,605 to Schenectady illustrates hydrogenation of STC in the presence aluminum granules at 400° C.

U.S. Pat. No. 2,458,703 to David B. Hatcher illustrates hydrogenation of STC in the presence of MGSI at reaction temperature of 310 to 350° C.

U.S. Pat. No. 2,499,009 to G. H. Wagner illustrates hydrogenation of STC in the presence of MGSI at reaction temperature of 310 to 350° C. catalyzed by copper compounds.

U.S. Pat. No. 2,595,620 to G. H. Wagner, et al. illustrates hydrogenation of STC in the presence of MGSI at various temperatures, pressure and retention time of STC in the reactor. Yield of TCS is less than 20% and the yield increased as the retention time increases.

U.S. Pat. No. 4,676,967 to William C. Breneman illustrates process of generating TCS plus STC from FBR operating at temperature range of 400 to 600° C. and pressure range of 300 to 600 psi.

All the chlorosilane products are changed into silane and introduced into a FBR for granular deposition of polysilicon. It does not need to convert STC.

U.S. Pat. No. 4,526,769 to William M. Ingle, et al. illustrates a process for producing trichloro-silane and equipment. The equipment is for two stage process which combines the reaction of silicon tetrachloride and hydrogen with silicon in lower portion of the equipment. Reaction of hydrogen chloride with silicon occurs in the upper portion of the equipment. It generates much more TCS than single hydrogenation of STC.

Masahito Sugiura, et al. illustrates that actual reaction that changes STC into TCS is not a single step reaction suggested by Breneman in the U.S. Pat. No. 4,676,967. Instead, it is series/parallel reaction of gas phase hydrogenation of STC combined with direct chlorination of MGSI. Union Carbide has commercialized a ‘bubbling bed’ mode FBR for producing polyolefin's of high density polyethylene and polypropylene and licensed the technology through out the world since 1980.

GT Solar, a U.S. company, announced a feasibility study report comparing old direct chlorination TCS-Siemens Process and their ‘Closed Loop Hydro chlorination’ process working at high temperature, high pressure. In the article, the maximum size of the plant which can be built by their technology is 7,000 MTA. But, even that number is for simulation, not a designed capacity.

However, none of the prior arts illustrates a hybrid TCS-Siemens process to reduce energy consumption and equipment investment for a polysilicon plant built by TCS-Siemens process of annual production capacity over 10,000 metric tons.

### SUMMARY OF THE INVENTION

The traditional TCS-Siemens process has been proved as successful commercial polysilicon process for decades. However, since 2007, it is known to the industry that it consumes huge amount of electricity to convert STC to TCS. After that, hydro chlorination FBR, in which STC is converted to TCS by hydrogenation in the presence of MGSI (Metallurgical Grade Silicon), is asked by many customers who want plant size smaller than 5,000 MT/YR polisilicon. But, after 2011 many big Asian chemical companies announced to build polysilicon plants of production capacity over 10,000 MT/YR to take advantage of scale merit of the polysilicon plant. However, the ‘closed loop’ hydro chlorination process has limit in scale up due to its' inherent problem of generating two times of STC than TCS at the same time. For, 10,000 MT/YR polysilicon plant, the amount of STC recycling in the process is 800,000 MT/YR. Recycling the huge amount of STC costs more operation cost and equipment investment. It is purpose of the current application to provide an economical process to save electricity and equipment cost in a polysilicon plant of size over 10,000 MT/YR. A method of saving electricity and investment cost from processes for TCS (Trichlorosilane) synthesis and regeneration of STC (Silicon Tetra Chloride) of a TCS-Siemens process for polysilicon plants size over 10,000 MT/YR is provided. Three different TCS-Siemens processes of 1) a traditional TCS-Siemens Process, 2) a ‘closed loop’ hydro-chlorination Siemens Process, and 3) a hybrid TCS-Siemens process are compared based on mass balance calculation. A hybrid TCS-Siemens equipped with a direct chlorination FBR (Fluidized Bed Reactor), which is disclosed in the U.S. Patent Application Publication No. 20100264362 of the applicants of current invention, saves at least 78,000,000 Kwhr per year from TCS generation only in a 10,000 MTA polysilicon plant compared with a same capacity polysilicon plant built by ‘Closed Loop TCS-Siemens Process.’ Compared with traditional TCS-Siemens Process, the ‘Hybrid TCS-Siemens Process’ saves 220,000,000 Kwhr per year from 10,000 MT/YR polysilicon plant.

### BRIEF DESCRIPTION OF DRAWINGS

FIG. 1 is a temperature profile inside of a FBR (Fluidized Bed Reactor) operating direct chlorination of MGSI only with MGSI and HCl along the reaction time.

FIG. 2 is a temperature profile inside of a FBR operating direct chlorination of MGSI with ‘turbo charger’, which is inert charging material, along the reaction time.

FIG. 3 is mean average temperature deviations inside of fluidizing bed for the MGSI only direct chlorination and in the presence of ‘turbo charger’ along the reaction time.

FIG. 4 is a schematic block diagram of old direct chlorination FBR equipped TCS-Siemens process showing TCS and STC mass flow in case of 10,000 MT/YR polysilicon plant.

FIG. 5 is a FBR for direct chlorination of MGSI in the presence of ‘turbo charger’.

FIG. 6 is an elevated view of a gas distributor used in the FBR for direct chlorination of MGSI in the presence of ‘turbo charger’.

FIG. 7 is a schematic block diagram of ‘Turbo Charger’ direct chlorination FBR equipped TCS-Siemens process showing TCS and STC mass flow in a 10,000 MT/YR polysilicon plant.

FIG. 8 is a schematic block diagram of ‘Closed Loop’ Hydro chlorination FBR equipped TCS-Siemens process showing TCS and STC mass flow in a 10,000 MT/YR polysilicon plant.

FIG. 9 is a schematic block diagram of ‘Turbo Charger’ direct chlorination FBR equipped ‘Hybrid’ TCS-Siemens process showing TCS and STC mass in a 10,000 MT/YR polysilicon plant.

FIG. 10 is a schematic block diagram of old direct chlorination FBR equipped ‘Hybrid’ TCS-Siemens process showing TCS and STC mass in a 10,000 MT/YR polysilicon plant.

### DETAILED DESCRIPTION OF PREFERRED EMBODIMENT

In spite of many technologies of direct chlorination of MGSI to generate TCS, none of them was reported as stable enough to produce high purity crude TCS from the FBR used. The applicant has disclosed the reason of such instability in a previous U.S. patent application Ser. No. 12/802,320, which is now published as application publication NO. 20100264362.

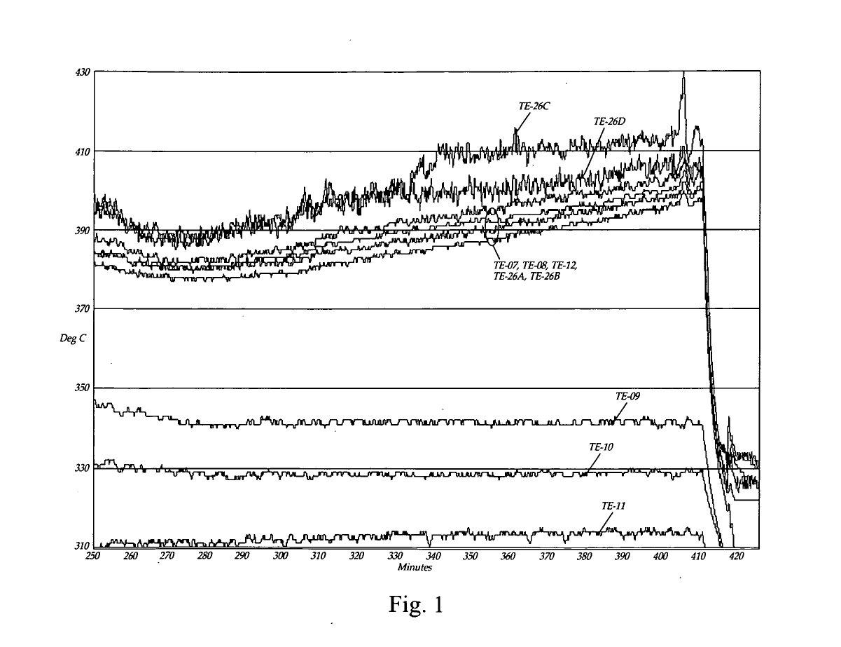

FIG. 1 is a temperature profile inside of a FBR operating direct chlorination of MGSI only with MGSI and HCl, like an old direct chlorination method, along the reaction time. Lines TE-26A to TE-26D indicate temperature readings at four corners of gas distribution plate, which placed at the bottom of the FBR. From Lines TE-07 to TE-11, the number means temperature reading from thermocouples locates vertically away from the bottom of the FBR with interval of distance equivalent to internal diameter of lower section of the FBR. FIG. 1 clearly shows that temperature profiles in old direct chlorination method are very irregular, unstable. Most of all, temperature inside of the fluidizing bed steadily increased. Because of such steady temperature increase the, FBR running with old direct chlorination should be shut down every 2 to 3 months. For continuous TCS production, at least two FBRs of the old types are recommended for continuous operation.

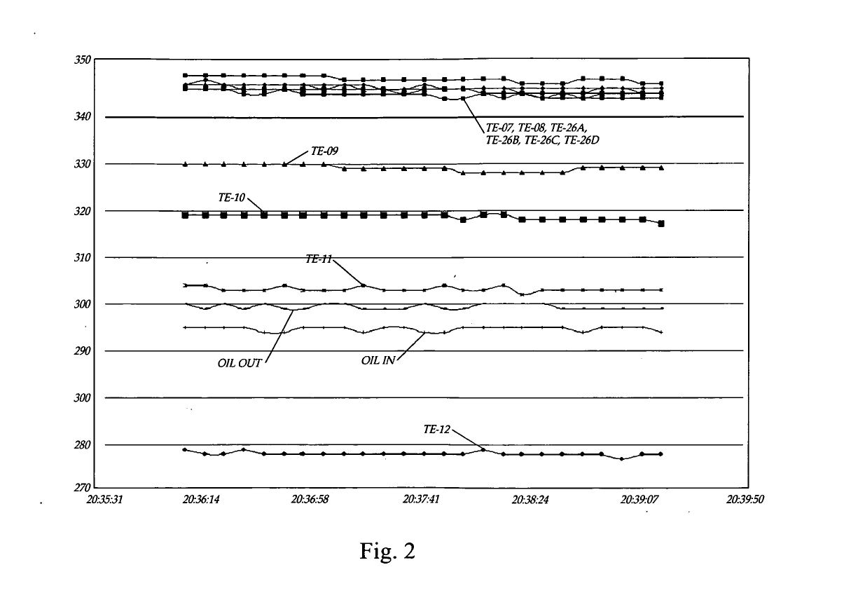

FIG. 2 is a temperature profile inside of a FBR operating direct chlorination of MGSI with ‘turbo charger’, which is inert charging material, along the reaction time. The ‘turbo charger’ is a material that does not react with HCl and other chlorosilanes, which are produced at the reaction condition. The ‘turbo charger’ is, including but not limited to, non-porous silica powder or porous silica powder, such as Grace Davison 952, quartz powder, glass beads, zirconium powder, sand, diamond powder, ruby powder, gold powder, silver powder, sapphire powder, garnet powder, opal powder, any kind of gemstone powder, and powder of salt of metal, including but not limited to oxide and halides of metals, except iron compound. The ‘turbo charger’ should have elemental SiO₂ contents at least 0.1 wt %. Particle size, true density, and bulk density of the ‘turbo charger’ material is equivalent to that of the metallurgical silicon as shown in the Table 1.

TABLE 1
Properties

| | |
|---|---|
| Particle size (micro meter) | 100~150 |
| Bulk Density (g/cc) | 0.98~1.02 |
| True Density (g/cc) | 1.98~2.01 |
| SiO₂ content (wt %) | >0.1 |

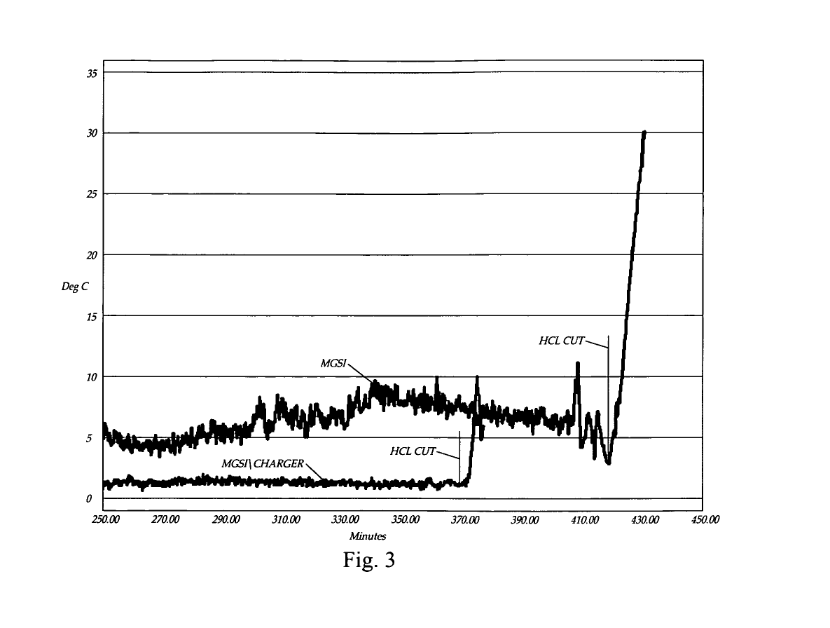

In FIG. 2, lines TE-26A to TE-26D indicate temperature readings at four corners of gas distribution plate, which placed at the bottom of the FBR. From Lines TE-07 to TE-11, the number means temperature reading from thermocouples locates vertically away from the bottom of the FBR with interval of distance equivalent to internal diameter of lower section of the FBR. In the ‘Turbo Charger’ direct chlorination method, as shown in FIG. 2, the temperature ridings of 4 points on the gas distribution plate and two points inside of the fluidizing bed are almost same temperature and do not change along the reaction time. Due to such advantages of the ‘Turbo Charger’ direct chlorination method, stable production of high purity crude TCS is possible. FIG. 3 is mean average temperature deviations inside of fluidizing bed for the MGSI only direct chlorination and in the presence of ‘turbo charger’ along the reaction time. Two different curves of mean average temperature deviations, from six different locations, inside of fluidizing bed of the FBR along the reaction time laps are recorded. The ‘MGSI’ marked line shows the temperature deviation when MGSI and HCl react according to old direct chlorination method and the ‘MGSI/CHARGER’ marked line shows the temperature deviation when MGSI reacts with HCl in the presence of the ‘turbo charger’.

The mean average temperature deviation was calculated by averaging the deviations between temperature at each location, among six locations, inside of the fluidizing bed and the average of the temperature at the six locations. As shown in the FIG. 3, the temperature inside of the fluidizing bed of the old direct chlorination method, packed the FBR with MGSI only, is very unstable and not uniform. This means that some point in the fluidizing bed is hotter than the other points. If that point is much hotter than the average bed temperature, it is called ‘hot spot’. In this ‘hot spot’ the reaction is different from the desired reaction and generates unwanted products, such as high molecular weight silicone products. These high molecular weight silicone molecules are viscous and reside at the bottom of a FBR to plug the holes of gas distribution plate. Once some holes of the gas distribution plate is plugged, the reactant gas, HCl, shifts to un-plugged holes and the velocity of the gas enters to the bed increases and ‘channeling’ of the bed happens and the bed temperature becomes more unstable. Most of all, the bed temperature increases steadily to reach over 500° C. At this temperature most of the product is known as STC, that is not desirable result.

But, the temperature profile of the direct chlorination of MGSI with ‘turbo charger’ is very uniform inside of the fluidizing bed. And the temperature is controlled within ±1° C. at about 350° C., the target temperature. According to FIG. 1 of the U.S. Pat. No. 3,148,035, selectivity of crude TCS from the FBR reaches over 95%.

A commercial direct chlorination FBR, which is built under contract with applicants, is reported to produces 95% purity crude TCS from the FBR, which is built by the design disclosed in the applicants' U.S. patent application Ser. No. 12/802,320, at much lower pressure and temperature compared to other methods.

Before the development of the applicant's ‘turbo charger’ direct chlorination FBR, all the previous direct chlorination FBR could not control the hot exothermic reaction and must shut down every 2 to 4 months. In addition to that there is limit of size of the FBR due to the poor heat control of the reaction.

### TCS and STC Mass Flows in Various TCS-Siemens Processes Over 10,000 MT/YR Capacity

For the following calculations, the CVD (Chemical Vapor Deposition) reactors, Siemens reactors, are regarded as the same commercial reactors. Therefore, the inlet rate of TCS in to the CVD reactor is fixed as 470,000 MT/YR and the outlet gas rate and compositions are regarded all the same in every different process. Typically, one commercial CVD reactor produces 200 to 500 MT/YR of polysilicon. For convenience, all the CVD reactors are presented as one block diagram. Unit of the numbers in the Figures are 1,000 MT/YR.

1. TCS-Siemens Process with Old Direct Chlorination Methods.

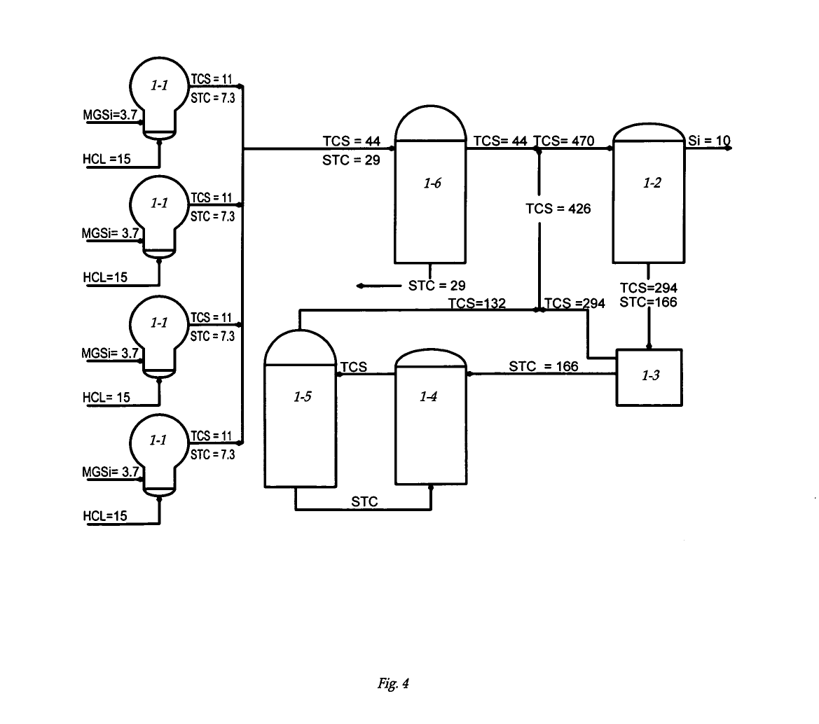

FIG. 4 is a schematic block diagram of old direct chlorination FRS (1-1) equipped TCS-Siemens process showing TCS and STC mass flow in case of 10,000 MT/YR polysilicon plant. Due to the heat transfer limit shown in the previous section, at least four small FBR are needed to produce enough TCS for 10,000 MT/YR polysilicon plant as shown in the FIG. 4. In addition to the often shut down, the selectivity of crude TCS from the FBR is 60% and most of the rest is reported as STC.

As assumed before 470,000 MT/YR of TCS is introduced into pluralities of CVD reactors (1-2) to produce 10,000 MT/YR of polysilicon. Then 294,000 MT/YR of TCS comes out of the CVD reactors as un-reacted and 166,000 MT/YR of STC comes out of the CVD reactors (1-2) as a gas mixture. These mixture gases are transferred to OGR (off gas recovery) system (1-3) that also includes a separator system (not shown in the drawing) to separate TCS and STC. TCS, after separated from STC, is recovered and returned into the CVD reactors (1-2). Meanwhile, the STC is transferred into thermal converters (1-4) to be converted into STC by hydrogenation. All the STC of 166,000 MT/YR is converted into 132,000 of MT/YR of TCS and joined with the 294,000 MT/YR of TCS to reach 426,000 MT/YR of TCS recycle stream. Once the STC goes into the thermal converter (1-4) about 20% of STC is converted into TCS at one pass. Then, the converted TCS and un-converted STC mixture is introduce another separator system (1-5). Then, un-reacted STC returns to the thermal converter (1-4) and the converted TCS goes to the TCS recycle stream. Finally, all the 166,000 MT/YR of STC converted into 132,000 MT/YR of TCS. Another separator system (1-5) may roles as the separator system of the OGS system (1-3). Since 470,000 MT/YR of TCS is needed to produce 10,000 MT/YR, additional 44,000 MT/YR of TCS is generated from direct chlorination. But, for old direct chlorination reactor the selectivity of TCS is 60% and the rest of 40% is STC. Therefore, 29,000 MT/YR of unwanted extra STC is generated. This STC can be converted to TCS after separated from third separator system (1-6). The third separator system (1-6) may roles as another separator system (1-5) and the separator system of the OGS system (1-3).

But, if this extra TCS is returned into the recycle stream, the TCS balance is broken. Therefore, the extra STC can be sold to other customer or converted into TCS for emergency TCS supply or sold to customers who need TCS. However, the power consumption rate of the thermal converter, 25 Kwhr/Kg Si, should be kept in mind.

2. TCS-Siemens Process Equipped with ‘Turbo Charger’ Direct Chlorination FBR.

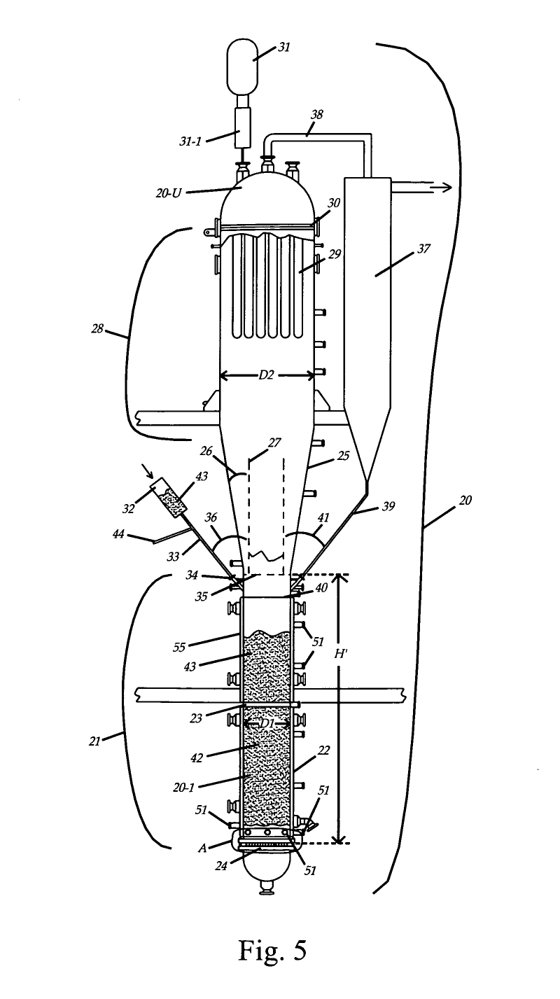

FBR (fluidized bed reactor) (20) for TCS production by direct chlorination of MGSI in the presence of ‘turbo charger’ is shown in the FIG. 5. The key features of the FBR (20) are as follows;

In the lower reactor section (21) of the FBR (20), the ratio of the height of the straight zone (H′) over internal diameter (D₁) is fixed between one to eleven. Cooling jacket (22) surrounds the outer surface (23) of the lower reactor section (21).

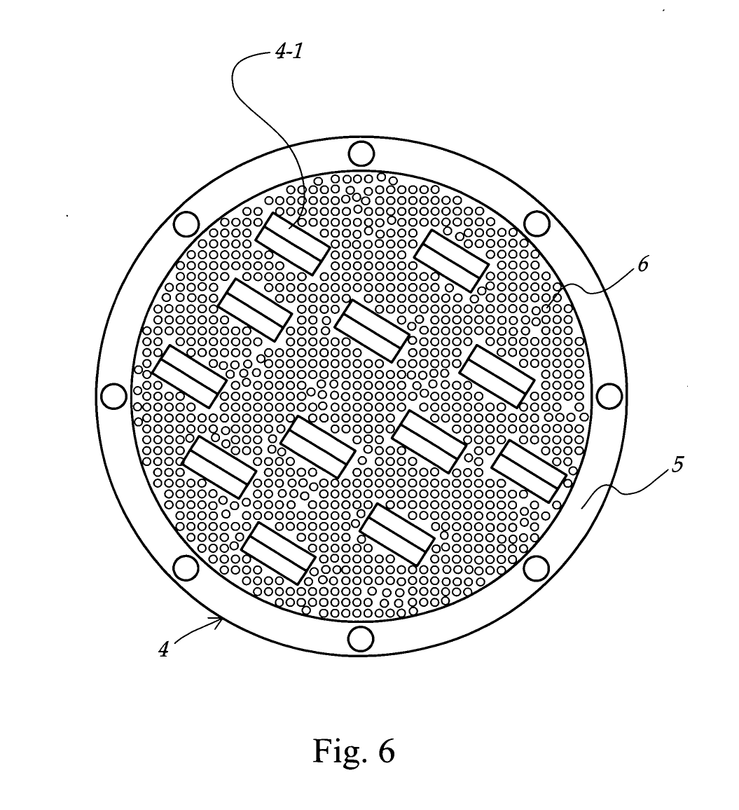

A gas distribution plate (24), which has pluralities of small holes (6) and chevron type hole caps (4-1) as shown in the FIG. 6, is installed at the bottom of the lower reactor section (21). An expanding zone (25) maintains an angle (26) from a vertical line (27), which is extended from the wall of the lower reactor section, smaller than 7 degree and expands until the inner diameter (D₂) of the upper reactor section (28) reaches over two times of the inner diameter (D₁) of the lower reactor section (21).

An internal cooler (29) may be installed inside of the upper reactor section (28) via a flange (30) for easy replacement of cooler (29). However, the lower end of the internal cooler (29) locates at least 6 m above the upper surface of the fluidizing bed to avoid severe erosion. In another embodiment, there is no internal cooler.

A ‘turbo charger’ hopper (31) is installed at the top of the upper reactor section to dump in the ‘turbo charger’ at the start up of the FBR (20). A powder feeder-1, named as ‘turbo charger’ feeder, (31-1), installed between the ‘turbo charger’ hopper (31) and the top dome section (20-U), introduces the ‘turbo charger’ to the FBR (20) to maintain the content of the ‘turbo charger’ material in the fluidizing bed (20-1). The ‘turbo charger’ feeder (31-1) shows ±5% accuracy of feeding the ‘turbo charger’ within the pressure range up to 10 bar and within the feeding rate range of 1 kg/hr to 10,000 Kg/hr.

The ‘turbo charger’ is chosen from solid material, except iron compounds, that does not react with any kind of chemicals which supposed to be generated during the hydro chlorination of silicon at reaction temperature up to 600° C. and reaction pressure of 30 bar.

Another powder feeder, MGSI feeder (32), is connected to the FBR (20) via a feeding line (33) that reaches a point (34) just below the upper end (35) of the lower reactor section (21) with an angle (36) from a vertical line (27), which is extended from the wall of the lower reactor section (21), smaller than 20 degrees. MGSI (43) is fed to the FBR (20) via the MGSI feeder (32). The MGSI feeder (32) may be the same type as the ‘turbo charger’ feeder (31-1).

A cyclone (37) is connected to the FBR (20) via an exit gas line (38) from the top of the FBR (20) and via a recycling line (39) that reaches a point (40), just below the upper end (35) of the lower reactor section (21), with an angle (41) from a vertical line (27) smaller than 20 degrees. Pluralities of thermocouples (51), 2 to 36, are installed along the brim of the gas distribution plate (24), and 2 to 36 thermocouples are installed along the height of the FBR (20). The temperature reading tells real-time information inside of the FBR (20).

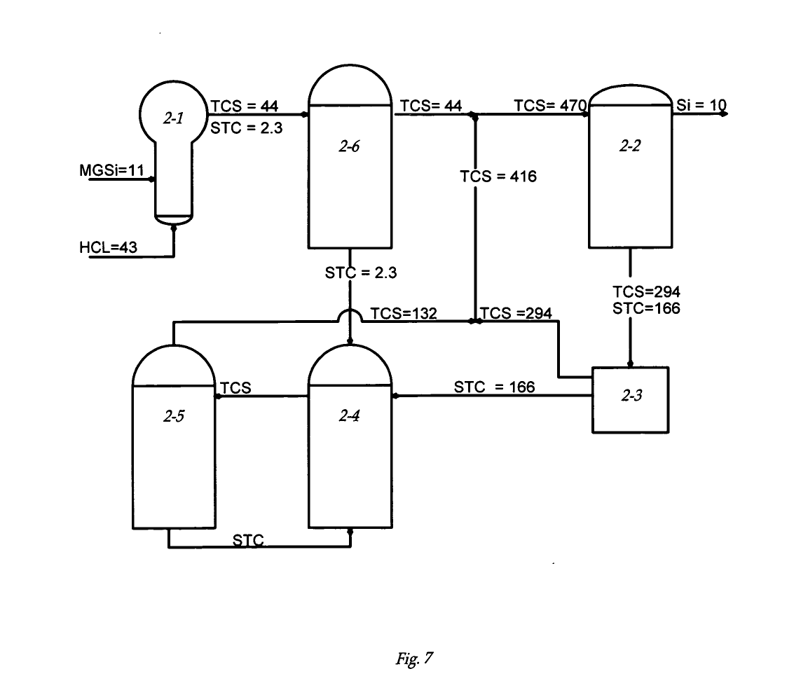

FIG. 7 is a schematic block diagram of ‘Turbo Charger’ direct chlorination FBR (2-1) equipped TCS-Siemens process showing TCS and STC mass flow in a 10,000 MT/YR polysilicon plant. Due to efficient heat transfer inside of the fluidizing bed, the ‘turbo charger’ direct chlorination produces crude TCS with minimum selectivity of 95%, STC is 5%. Since the CVD reactors (2-2) are the same, 470,000 MT/YR of TCS is introduced into CVD reactors (2-2) to produce 10,000 MT/YR of polysilicon. Then 294,000 MT/YR of TCS comes out of the CVD reactors (2-2) as un-reacted and 166,000 MT/YR of STC comes out of the CVD reactors (2-2) as a gas mixture. These mixture gases are transferred to OGR system (2-3) that also includes a separator system (not shown in the drawing) for separation of TCS and STC. TCS, after separated from STC, is recovered and returned into the CVD reactors (2-2). Meanwhile, the STC is transferred into thermal converters (2-4) to be converted into STC by hydrogenation. All the STC of 166,000 MT/YR is converted into 132,000 of MT/YR of TCS and joined with the 294,000

MT/YR of TCS to reach 426,000 MT/YR of TCS recycle stream. Once the STC goes into the thermal converter (2-4) about 20% of STC is converted into TCS at one pass. Then, the converted TCS and un-converted STC mixture is introduce another separator system (2-5). Then, un-reacted STC returns to the thermal converter (2-4) and the converted TCS goes to the TCS recycle stream. Finally, all the 166,000 MT/YR of STC converted into 132,000 MT/YR of TCS. Another separator system (2-5) may roles as a separator system in the OGR system (2-3).

Since 470,000 MT/YR of TCS is needed to produce 10,000 MT/YR, additional 54,000 MT/YR of TCS is generated from direct chlorination. Since the ‘turbo charger’ direct chlorination FBR (2-1) shows 95% TCS selectivity, about 3,000 MT/YR of STC is generated. This amount is less than 10% of the amount of STC generated from old direct chlorination FBR. It can be sold to customer after separated from TCS in third separator system (2-6) or can be converted to TCS and saved as emergency TCS source. However, still the electricity consumption by the thermal converters is major concern for operation cost. The third separator system (2-6) may roles as another separator system (2-5) and the separator system in the OGR system (2-3).

3. TCS-Siemens Process Equipped with ‘Closed Loop’ Hydro Chlorination FBR Operating at High Temperature and High Pressure.

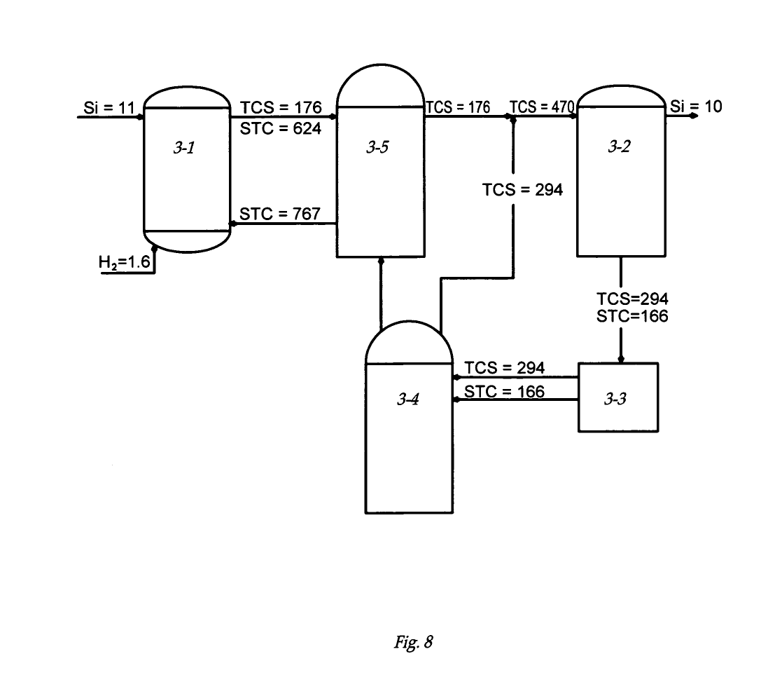

FIG. 8 is a schematic block diagram of ‘Closed Loop’ Hydro chlorination FBR (3-1), which operates at about 550° C. and 25 bar, equipped TCS-Siemens process showing TCS and STC mass flow in a 10,000 MT/YR polysilicon plant.

As shown in the many prior arts, the hydro chlorination reaction as equation (1) has very poor selectivity of TCS in the products. It is known as around 20 to 25%. 22% selectivity of TCS in the crude product was used.

Si+2H₂+3STC→4TCS (1)

In the ‘closed loop’ hydro chlorination TCS-Siemens process, one hydro chlorination reactor, which operates around 500° C. to 600° C. and 20 to 30 bar, generates TCS and consumes STC at the same time. So all the STC generated from the CVD reactors (3-2) are sent to hydrogenation FBR after purification in the OGR system (3-3) and separated in a separator system (3-4). Amount of TCS directly returned to CVD reactors are the same as the two previous processes, 294,000 MT/YR. Same as the two previous TCS-Siemens processes, 470,000 MT/YR of TCS is needed to produce 10,000 MT/YR. Therefore, 176,000 MT/YR of additional TCS is generated from the hydro chlorination FBR (3-1). Until now, it is not a big problem. But, due to the inherent nature of the hydro chlorination reaction, 22% TCS selectivity in crude product from the hydro chlorination FBR (3-1), 615,000 MT/YR of STC is generated at the same time. Then total amount of chlorosilane produced is about 800,000 MT/YR. It is not easy to generate such huge amount of chlorosilane from one single FBR. Moreover, another huge separator system (3-5) is necessary to separate the huge amount of STC from TCS. The huge separator system (3-5) may roles as the separator system (3-4) following the OGR system (3-3). In addition to this, as shown in the FIG. 8, about 772,000 MT/YR of STC is returned to the hydro chlorination FBR (3-1). In other words, about 800,000 MT/YR of chlorosilane is repeatedly heat up, compresses and condensed again and again.

As disclosed in the many previous articles, the hydro chlorination reactor, as disclosed in the U.S. Pat. No. 4,676,967, should be built with especially expensive material, Inconel 800 H, because of the high reaction temperature, over 500° C., and reaction pressure, over 25 bar.

### 4. Hybrid TCS-Siemens Process

4-A; Hybrid TCS-Siemens Process with ‘Turbo Charger’ Direct Chlorination FBR.

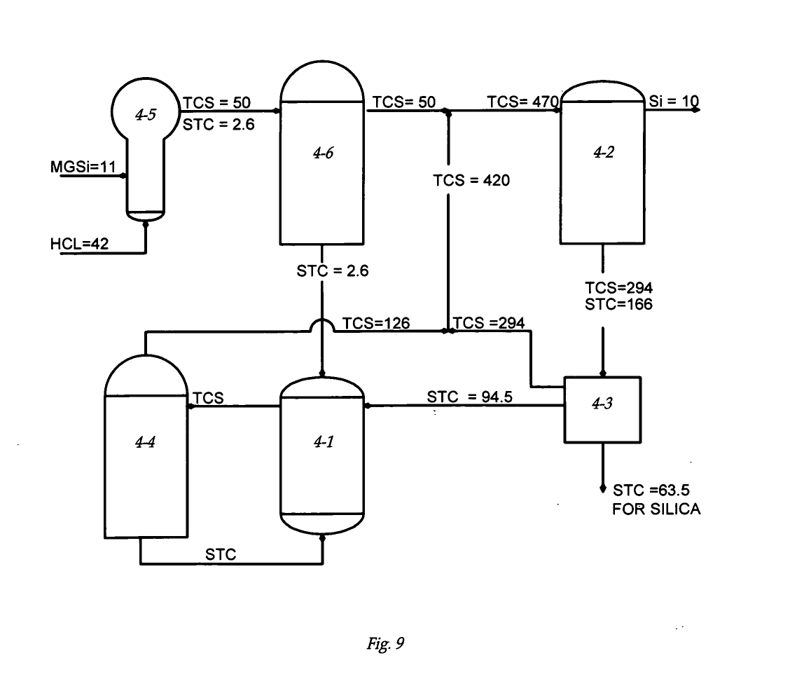

To reduce the enormous amount of electricity consumption by thermal converters, relatively small hydro chlorination FBR (4-1), which operates at about 550° C. and 25 bar, is suggested for converting STC to TCS. The process is named as ‘Hybrid TCS-Siemens Process.’ The process block diagram of the ‘Hybrid TCS-Siemens Process’ is illustrated in FIG. 9.

As assumed before 470,000 MT/YR of TCS is introduced into pluralities of CVD reactors (4-2) to produce 10,000 MT/YR of polysilicon. Then 294,000 MT/YR of TCS comes out of the CVD reactors as un-reacted and 166,000 MT/YR of STC comes out of the CVD reactors (4-2) as a gas mixture. These mixture gases are transferred to off OGR system (4-3) that also includes a separator system for separation of TCS and STC. 294,000 MT/YR of TCS, after separated from STC, is recovered and returned into the CVD reactors (4-2).

For STC, some technical modification is needed to resolve problems of inherent hydro-chlorination. If all the STC from OGR system (4-3) is put into the hydrochlorination FBR (4-1), it generates more moles of TCS than STC according to the equation (1). Then we have excess TCS that breaks the steady state mass balance of the entire process. To avoid such undesirable situation, part of STC is removed from the process to meet the TCS overall balance. The amount of STC removed is 38% of STC from OGR system (4-3). The removed STC is reacted with pure water to recycle HCl and make SiO₂ for sales or use in the process. Or, the total STC is converted to TCS and the extra TCS is reserved for emergency or sell at other chemical industry after purification in first separator system (4-4). The first separator system (4-4) may role as the separator system included in the OGR system (4-3)

Then, the rest 94,500 MT/YR of STC is converted into 126,000 MT/YR of TCS. Therefore, total 420,000 MT/YR of TCS is recovered from the CVD Off gas. To meet the assumption of 470,000 MT/YR of TCS for 10,000 MT/YR of polysilicon, only 50,000 MT/YR of TCS should be generated from ‘turbo charger’ direct chlorination FBR (4-5).

As proven by the customer and the previous temperature profile data, the ‘turbo charger’ direct chlorination FBR (4-5) shows crude TCS selectivity over 95%. Therefore, only 2,500 MT/YR of STC is generated. The STC is introduced into small STC to TCS converter (4-1), after separated from second separator system (4-6). The first separator system (4-4), the second separator (4-6) and the separator system in the OGR system (4-3) may be one separator system.

4-B; Hybrid TCS-Siemens Process with Old Direct Chlorination FBR.

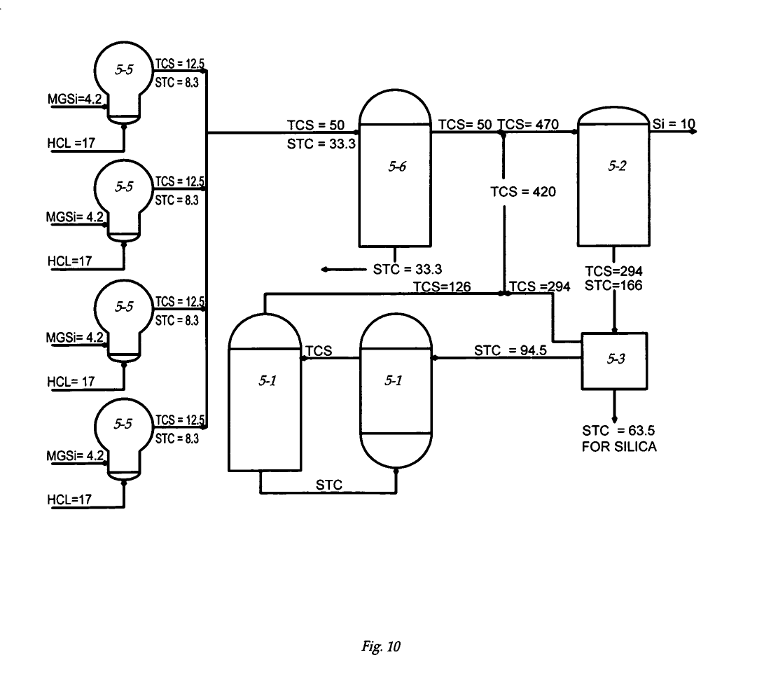

FIG. 10 is schematic block diagrams of old direct chlorination FBR equipped ‘Hybrid’ TCS-Siemens process showing TCS and STC mass in a 10,000 MT/YR polysilicon plant. As assumed before 470,000 MT/YR of TCS is introduced into pluralities of CVD reactors (5-2) to produce 10,000 MT/YR of polysilicon. Then 294,000 MT/YR of TCS comes out of the CVD reactors as un-reacted and 166,000 MT/YR of STC comes out of the CVD reactors (5-2) as a gas mixture.

These mixture gases are transferred to off OGR system (5-3) that also includes a separator system for separation of TCS and STC. 294,000 MT/YR of TCS, after separated from STC, is recovered and returned into the CVD reactors (5-2).

For STC, some technical modification is needed to resolve problems of inherent hydro-chlorination. If all the STC from OGR system (5-3) is put into the hydro chlorination FBR (5-1), it generates more moles of TCS than STC according to the equation (1). Then we have excess TCS that breaks the steady state mass balance of the entire process. To avoid such undesirable situation, part of STC is removed from the process to meet the TCS overall balance. The amount of STC removed is 38% of STC from OGR system (5-3). The removed STC is reacted with pure water to recycle HCl and make SiO₂ for sales or use in the process. Or, the total STC is converted to TCS and the extra TCS is reserved for emergency or sell at other chemical industry after purification in first separator system (5-4). The first separator system (5-4) may role as the separator system included in the OGR system (5-3)

Then, the rest 94,500 MT/YR of STC is converted into 126,000 MT/YR of TCS. Therefore, total 420,000 MT/YR of TCS is recovered from the CVD Off gas. To meet the assumption of 470,000 MT/YR of TCS for 10,000 MT/YR of polysilicon, only 50,000 MT/YR of TCS should be generated from old direct chlorination FBR (5-5).

However, as proven by many existing TCS-Siemens polysilicon plants, pluralities of small old direct chlorination FBR (5-5) s, each of them generating few thousand MT/YR TCS, are installed in a plant to compensate for the scale up limit of the old direct chlorination FBR due to difficult reaction heat control. In addition to that the purity of crude TCS out of the old direct chlorination FBR is about 60% due to poor reaction temperature control. Therefore, 33,000 MT/YR of STC is produced as un-wanted by product to produce 50,000 MT/YR of TCS. This amount of 33,000 MT/YR of STC is about 20% of STC generated from the CVD reactors (5-2).

In the previous step of 4-A; Hybrid TCS-Siemens process with ‘turbo charger’ direct chlorination FBR, 30% of STC from the CVD reactors (5-2) are not converted into TCS by the hydro-chlorination FBR (5-1) to keep the overall TCS mass flow in balance. Instead the un-converted STC is planned to sale for economical use. However, the old direct chlorination FBRs (5-5) produce enough amount of un-wanted by product STC to compensate for the effect of draw out of STC from the process.

As a conclusion, the ‘Hybrid TCS-Siemens process’ equipped with pluralities of old direct chlorination FBRs are much less economical compared to the other ‘Hybrid TCS-Siemens process’ equipped with a single ‘turbo charger’ direct chlorination FBR.

### 5. Total Energy Consumption for TCS Production in Each Process

Total energy consumption related with TCS generation and STC conversion for the above mentioned ‘Closed Loop TCS-Siemens Process’, the above mentioned traditional ‘TCS-Siemens Process’, and the above mentioned ‘Hybrid TCS-Siemens Process’ are listed in Table 2 for comparison. The total energy consumption related with TCS generation and STC conversion is calculated by adding the energy convert STC to TCS and separation. The numbers are collected from commercial plants.

Table 2 clearly shows that the traditional ‘TCS-Siemens Process’ using ‘Thermal Converter’ consumes energy most. The ‘Closed Loop TCS Siemens Process’ consumes about 40% of energy compared to the traditional process. The ‘Hybrid TCS-Siemens Process’ consumes less than 10% of energy compared to the traditional ‘TCS-Siemens Process.’ Here, the FBR used for direct chlorination is the new ‘Turbo Charger’ FBR. Therefore, the hybrid TCS-Siemens process equipped with ‘turbo charger’ FBR is the most economical process to generate TCS in large scale polysilicon plant of size over 10,000 MT/YR.

As shown in the Table 2, The ‘Hybrid TCS-Siemens Process’ using ‘turbo charger’ direct chlorination FBR saves 78,211,145 Kwhr per year than the ‘Closed Loop TCS Siemens’ that has a FBR operates at about 550° C. and 25 bar from a 10,000 MT/YR polysilicon plant. Compared to the old traditional ‘TCS-Siemens process’ that uses ‘thermal converters’, the ‘Hybrid TCS-Siemens process’, saves 218,201,139 Kwhr per year from a 10,000 MT/YR polysilicon plant. These are equivalent to 7.8 Kwhr/kg Si and 21.9 Kwhr/kg Si electricity savings.

TABLE 2
Energy consumption related with STC conversion and TCS generation in
three different Siemens Processes for 10,000 MTA Polysilicon Plant *

| | Mass to Converter | Converter Energy | | |
|---|---|---|---|---|
| | MT/YR | Kwhr/kg Si ** | Toatal (Kwhr) | 1,000 Kwhr |
| (A); Closed Loop | 800,000 | 10 (Hydro- | 10 × 10,000,000 = | 100,000 |
| TCS-Siemens | | Chlorination) | 100,000,000 | |
| TCS-Siemens | 166,000 | 20 for TC | 24 × 10,000,000 = | 240,000 |
| | | 4 for DC | 240,000,000 | |
| (B); Hybrid | 94,500 | 1.18 ^{†} for HC | 2.18 × 10,000,000 = | 21,800 |
| TCS-Siemens | | 1 for DC | 21,800,000 | |
| (A) − (B) | 705,500 | 7.818 | | 78,200 |

* Energy consumption in Distillation, Siemens Reactor, and Off Gas Recycle steps are not considered because they are common steps for all the three processes.
** Energy consumption from commercial plants. Includes heater, cooler and compressor power consumption.
^{†} 10 × (94,500/800,000); Reduction of H.C. reactor size reduces energy consumption.

### Reactor Sizes and Initial Capital Investment

In addition to lower energy consumption in STC conversion and TCS generation, the ‘Hybrid TCS-Siemens Process’ has another advantage over the ‘Closed Loop TCS-Siemens process’ in terms of reactor sizes due to its inherent disadvantage of the hydro chlorination.

The ‘Turbo Charger’ FBR, adopted in direct chlorination process of the ‘Hybrid TCS-Siemens Process, is operated at a controlled temperature between 300˜350° C. and at a pressure range about 5 bar. The FBR can be manufactured with various construction materials such as carbon steel, stain less steel, and Inconel®.

Meanwhile, since hydro chlorination FBR reactor of U.S. Pat. No. 4,676,967 operates at high temperature of 550° C., and high pressure above 25 bar, that FBR must be constructed with the expensive Incoloy 800 H® or equivalent material for safety reason. In addition to this, due to complex internal structure, difficult level control, and excess side product, it is almost impossible to build a single large hydro chlorination FBR, which has a capacity to produce 10,000 MT/YR of TCS. This size is equivalent to produce TCS for 6,000 MT/YR polysilicon plant built by the ‘Closed Loop TCS-Siemens Process’.

On the other hand, the ‘Turbo Charger’ FBR for direct chlorination, developed by the applicants' genuine in-house technology, has totally different from the old FBR for direct chlorination and the FBR for hydro chlorination disclosed in the U.S. Pat. No. 4,676,967. One key feature of the ‘turbo charger’ direct chlorination FBR is to control the reaction in stoichiometrically equivalent, which is impossible for the other two FBRs. The other key feature is operating the fluidizing bed in ‘Bubbling Bed Mode’ that maximize mixing of the bed material.

Meanwhile, the other two type FBRs are just large scale reactor of a laboratory state reactor. They just pile up unnecessarily excess amount of MGSI in a FBR without considering movement of the bed material. Therefore, the fluidizing bed, where the reaction occurs is in an ‘extended fixed bed’ or ‘slugging bed’ mode, is unstable and the reactant gas feeding rate is limited. Due to the limitation, the heat of the reaction is controlled by only ‘conductional heat transfer’ and as a result temperature profile in the reaction zone is unstable and not uniform.

The new FBR for direct chlorination utilize an inert medium named as ‘turbo charger’ inside the fluidizing bed to dilute heat generated per vole of the bed and at the same time transfer the heat generated to the reactor wall by ‘Convectional Heat transfer’ due to the ‘Bubbling Bed Mode’ movement of the bed material.

Features of the ‘turbo charger’ FBR for direct chlorination is listed in Table 3 and compared with other two FBRs.

TABLE 3
Features of different FBRs for TCS Production

| | Old Direct | Turbo Charger Direct | Hydrochlorination |
|---|---|---|---|
| | Chlorination FBR | Chlorination FBR | FBR |
| Temperature (° C.) | 300~400 | 300~350 | 520~550 |
| Pressure (bar) | 4~5 | 5 | 25~30 |
| Δ T across bed | >±10° C. | <±1° C. | >±10° C. |
| Bed Mode | Extended ~Slugging | Bubbling* | Extended Fixed Bed |
| Reaction | Non-Stoichiometric | Stoichiometric | Non-Stoichiometric |
| Cooler | Internal Cooling Coil | External Cooling | External Heater |
| | | Jacket | |
| Inside Bed Cooling | STC, N₂, H₂ and O₂ | Turbo Charger | STC, H₂ |
| Medium | gases | | |
| Thermal Conductivity | 0.1~0.2 W/(mK) | 1~2 W/(mK) | 0.1~0.2 W/(mK) |
| Internals | Cooling Coil, Bubble | None | Bubble Breaker, |
| | Breaker | | Internal Cyclone |
| Bed Level Control | Semi-Auto | Auto | Semi-Auto |
| Specific Gas Velocity | <20 cm/sec | 20~60 cm/sec** | 6~10 cm/sec |
| Crude TCS Selectivity | 60~90% | >95% | <30% |
| Up-Time | ~40% | >90%, 11 months | >90%, 11 months |
| Scale-up limit, | 15,000 | 500,000 | 96,000*** |
| MT/YR TCS | | | |
| Reason of limit | Hot Spot, Poor | Mechanical | Mechanical |
| | heat transfer | Structure | Structure |
| Construction Material | Cabon steel, SUS, | Carbon steel, SUS, | Incoloy |
| | Incoloy | Incoloy | |

*Bed Mode; Bubbling bed mode shows maximum mixing
**High SGV enables the bed material convects. So, convectional heat transfer is possible.
***For 96,000 MTA TCS at least 288,000 MTA STC is generated from the same FBR

The result of such effective heat transfer control is shown in the FIG. 1 as the uniform temperature profile inside of the fluidizing bed, the reaction zone.

Since this new ‘Turbo Charger’ FBR has no internal structure, it is easy to scale-up. For example, Union Carbide commercialized similar ‘Bubbling Bed Mode’ FBR, Uniopl® Reactor, for Polyolefin production. Since 1980 about 100 reactor of 100,000 MTA are commercially in operation without any single accident. Maximum size of the reactor is 500,000 MTA from single reactor.

GT Solar, a U.S. company, announced a feasibility study report comparing old direct chlorination TCS-Siemens Process and their ‘Closed Loop Hydro chlorination’ process working at high temperature, high pressure. In the article, the maximum size of the plant which can be built by their technology is 7,000 MTA. But, even that number is for simulation, not a designed capacity.

Due to the limitations of the previous TCS-Siemens processes discussed above a new process is needed to build a large scale polysilicon plant over 10,000 MT/YR to save Opex and CaPex. Size and number of FBRs for TCS production for 10,000 MT/YR and 20,000 MT/YR polysilicon plant according to three different processes are summarized in Table 4. Specific cost is not estimated because material cost and fabrication cost are different for each plant site. Sizes of each reactor are based on commercial reactors.

As shown in the Table 4, at least 4 to 8 FBRs are needed to comprise a ‘Hybrid TCS-Siemens Process’ using old direct chlorination TCS FBR. In this case, due to frequent shut-down of the FBR, additional maintenance man power is needed and the possibility of malfunction of the FBR is very high.

Meanwhile, with applicants' new ‘turbo charger’ FBR automatically produces enough TCS through a whole year without shut-down of the FBR. Therefore, initial capital investment for TCS production is reduced down.

TABLE 4
Size and number of FBRs for TCS production for 10,000 MTA and 20,000
MTA Polysilicon plant according to three different processes.

| | TCS | | | H.C. FBR | | |
|---|---|---|---|---|---|---|
| | FBR: | No. of | | MT/YR | No. of H.C. | |
| | MT/YR | FBR | Dimension | STC Only | FBR | Dimension |
| Hybrid | 83,000 | 4 | Ø1.5 m, H 25 m | 95,000 | 1 | Ø1.4 m, H 25 m |
| with Old | (166,000) | 8 | Ø1.5 m, H 25 m | 190,000 | 1 | Ø2.1 m, H 25 m |
| D.C. FBR | | | | | | |
| Hybrid with | 53,000 | 1 | Ø1.5 m, H 25 m | 95,000 | 1 | Ø1.4 m, H 25 m |
| ‘Turbo’ | (106,000) | 1 | Ø 2.2 m, H 25 m | 190,000 | 1 | Ø2.1 m, H 25 m |
| D.C. FBR | | | | | | |
| H.C. Closed | 0 | 0 | | STC + | No. of FBR | |
| Loop FBR | | | | TCS | 400,000 | |
| | | | | | MT/YR | |
| | | | | 800,000 | 2 | Ø3.0 m, H 25 m |
| | | | | 1,600,000 | 4 | Ø3.0 m, H 25 m |

On the other hand, ‘Closed Loop TCS-Siemens Process’ does not need separate FBR for TCS production only. However, TCS is generated from one hydrochlorination FBR with un-necessarily huge amount of STC at the same time. Therefore, the size and number of hydro chlorination FBR increases.

To build one polysilicon plant of 10,000 MTA or 20,000 MTA by ‘Hybrid TCS-Siemens Process’ using ‘Turbo Charger’ FBR, one small ‘Turbo Charger’ FBR for TCS production and one small REC type hydrochlorination FBR for STC converter is enough.

Meanwhile, at least 2 or 4 large hydro chlorination reactors, which has twice larger diameter than the Hybrid process case, are needed to build a 10,000 MTA or 20,000 MTA polysilicon plant by ‘Hydrochlorination Closed Loop TCS-Siemens Process’.

In addition to this, the FBR for this process should be built with the expensive Inconel 800H to secure the operation conditions of high temperature and high pressure. And at the same time size of super heater and settler, which are mandatory supplementary equipment to the FBR, should also be increased. As we know well, Inconl 800 H is very expensive and hard to fabricate. And the wall thickness of a pressure vessel increases with square of the diameter ratio of the vessels. Therefore, the price of FBR also increases with square of diameter ratio.

As a conclusion, initial capital investment for TCS production for ‘Hybrid TCS-Siemens Process is much smaller than ‘Closed Loop TCS-Siemens Process.’

‘Hybrid TCS-Siemens Process’ equipped with applicants' ‘Turbo Charger’ direct chlorination FBR saves at least 78,000,000 Kwhr per year from TCS generation only in a 10,000 M/YR. polysilicon plant compared with a same capacity polysilicon plant built by ‘Closed Loop TCS-Siemens Process.’ For 20,000 MT/YR plant the amount is 156,000,000 Kwh.

Compared with traditional TCS-Siemens Process, the ‘Hybrid TCS-Siemens Process’ saves 220,000,000 Kwhr per year from 10,000 MT/YR plant.

In addition to this, ‘Hybrid TCS-Siemens Process’ equipped with applicants' ‘Turbo Charger’ direct chlorination FBR saves huge amount of initial capital investment from TCS generation related equipment.

As a conclusion, ‘Hybrid TCS-Siemens Process’ equipped with applicants' ‘Turbo Charger’ direct chlorination FBR is the most economical process for a polysilicon process over 10,000 MT/YR capacities.

What is claimed is:

1. A hybrid TCS-Siemens process for building a polysilicon plant of scale larger than 10,000 MT/YR economically and save more electricity is comprised of;
a direct chlorination FBR (Fluidized bed reactor) that uses ‘turbo charger’ and is comprised of;
a lower reactor section of the fluidized bed, in which the ratio of the height of the straight zone (H′) over internal diameter (D₁) is fixed as six,
and
a cooling jacket surrounding the outer surface of the lower reactor section,
and
a gas distribution plate, whose brim is rounded concavely to form a smooth round inner surface between the vertical inner surface of the lower reactor section and the gas distribution plate which is installed at the bottom of the lower reactor section and which is equipped with pluralities of gas holes of diameter 2 mm and pluralities of chevron shape gas hole caps that cover the holes,
and
an upper reactor section,
and
an expanding zone locates between the lower reactor section and the upper reactor section and maintains an angle from a vertical line of 7 degree and expands until the inner diameter (D₂) of the upper reactor section reaches two times of the inner diameter (D₁) of the lower reactor section,
and
an internal cooler that is installed inside of the upper reactor section via a flange for easy replacement,
and
an initially charging material hopper that is installed at the top of the upper reactor section to dump in the seed bed material at the start up of the fluidized bed reactor,
and
an MGSI feeder that controls feeding rate of the silicon at a range of 100 Kg/hr with +5% deviation at a pressure of 150 Pisa and is connected to the fluidized bed reactor via a feeding line that reaches a point just below the upper end of the lower reactor section with an angle from a vertical line smaller than 20 degrees,
and
an initial charging material feeder that controls feeding rate of the initial charging material at a range of 100 Kg/hr with +5% deviation at a pressure of 150 Pisa and is connected to the fluidized bed reactor,
and
a cyclone that is connected to the fluidized bed reactor via an exit gas line from the top of the fluidized bed reactor and via a recycling line that reaches a point just below the upper end of the lower reactor section with an angle from a vertical line smaller than 20 degrees,
and
pluralities of thermocouples; four of them are installed along the brim of the gas distribution plate and twelve of them are installed along the height of the FBR to get real-time temperature information inside of the FBR,
and
a hydro chlorination FBR for converting STC (Silicon Tetra Chloride) to TCS (Tri Chloro Silane),
and
pluralities of CVD (Chemical Vapor Deposition) reactors for depositing silicon from TCS introduced,
and
a off gas recovery system that also includes a separator system for separating TCS and STC comes from the CVDs and returns TCS into the CVD reactors,
and
a first separator system that separates the STC and TCS from the hydro chlorination FBR,
and
a second separator system that separates TCS and STC produced from the direct chlorination FBR that uses ‘turbo charger’.

2. A hybrid TCS-Siemens process for building a polysilicon plant of scale larger than 10,000 MT/YR economically and save more electricity is comprised of;
a direct chlorination FBR (Fluidized bed reactor) that uses ‘turbo charger’ and is comprised of;
a lower reactor section of the fluidized bed, in which the ratio of the height of the straight zone (H′) over internal diameter (D₁) is fixed as six,
and
a cooling jacket surrounding the outer surface of the lower reactor section,
and
a gas distribution plate, whose brim is rounded concavely to form a smooth round inner surface between the vertical inner surface of the lower reactor section and the gas distribution plate which is installed at the bottom of the lower reactor section and which is equipped with pluralities of gas holes of diameter 2 mm and pluralities of chevron shape gas hole caps that cover the holes,
and
an upper reactor section,
and
an expanding zone locates between the lower reactor section and the upper reactor section and maintains an angle from a vertical line of 7 degree and expands until the inner diameter (D₂) of the upper reactor section reaches two times of the inner diameter (D₁) of the lower reactor section,
and
an initially charging material hopper that is installed at the top of the upper reactor section to dump in the seed bed material at the start up of the fluidized bed reactor,
and
an MGSI feeder that controls feeding rate of the silicon at a range of 100 Kg/hr with +5% deviation at a pressure of 150 Pisa and is connected to the fluidized bed reactor via a feeding line that reaches a point just below the upper end of the lower reactor section with an angle from a vertical line smaller than 20 degrees,
and
an initial charging material feeder that controls feeding rate of the initial charging material at a range of 100 Kg/hr with +5% deviation at a pressure of 150 Pisa and is connected to the fluidized bed reactor,
and
a cyclone that is connected to the fluidized bed reactor via an exit gas line from the top of the fluidized bed reactor and via a recycling line that reaches a point just below the upper end of the lower reactor section with an angle from a vertical line smaller than 20 degrees,
and
pluralities of thermocouples; four of them are installed along the brim of the gas distribution plate and twelve of them are installed along the height of the FBR to get real-time temperature information inside of the FBR,
and
a hydro chlorination FBR for converting STC (Silicon Tetra Chloride) to TCS (Tri Chloro Silane),
and
pluralities of CVD (Chemical Vapor Deposition) reactors for depositing silicon from TCS introduced,
and
a off gas recovery system that also includes a separator system for separating TCS and STC comes from the CVDs and returns TCS into the CVD reactors,
and
a first separator system that separates the STC and TCS from the hydro chlorination FBR,
and
a second separator system that separates TCS and STC produced from the direct chlorination FBR that uses ‘turbo charger’.

3. A hybrid TCS-Siemens process for producing polysilicon in scale of 10,000 MT/YR of claims 1 and 2, wherein the separator system included in the OGR system for separating TCS and STC come from the CVDs and returns TCS into the CVD reactors, the first separator system that separates the STC and TCS from the hydro chlorination FBR, and the second separator system that separates TCS and STC produced from the direct chlorination FBR that uses ‘turbo charger’ are one separator system.

4. A hybrid TCS-Siemens process for building a polysilicon plant of scale larger than 10,000 MT/YR economically and save more electricity of claims 1 and 2, the ‘hybrid TCS-Siemens Process’ saves 21.9 Kwhr/kg Si compared to old ‘TCS-Siemens Process’ that uses ‘thermal converters’ for STC conversion to TCS.

5. A hybrid TCS-Siemens process for building a polysilicon plant of scale larger than 10,000 MT/YR economically and save more electricity of claims 1 and 2, the ‘hybrid TCS-Siemens Process saves 7.8 Kwhr/kg Si compared to the ‘Closed Loop TCS Siemens Process’ that use a FBR that operates at about 550° C. and 25 bar to convert STC to TCS.

6. A hybrid TCS-Siemens process for building a polysilicon plant of scale larger than 10,000 MT/YR economically and save more electricity of claims 1 and 2, the ‘turbo charger’ is quartz powder.

7. A hybrid TCS-Siemens process for building a polysilicon plant of scale larger than 10,000 MT/YR economically and save more electricity of claims 1 and 2, the ‘turbo charger’ is is amorphous quartz powder.

8. A hybrid TCS-Siemens process for building a polysilicon plant of scale larger than 10,000 MT/YR economically and save more electricity of claims 1 and 2, the ‘turbo charger’ is sand.

9. A hybrid TCS-Siemens process for building a polysilicon plant of scale larger than 10,000 MT/YR economically and save more electricity of claims 1 and 2, the ‘turbo charger’ is non-porous silica powder.

10. A hybrid TCS-Siemens process for building a polysilicon plant of scale larger than 10,000 MT/YR economically and save more electricity of claims 1 and 2, the ‘turbo charger’ is porous silica powder.

11. A hybrid TCS-Siemens process for building a polysilicon plant of scale larger than 10,000 MT/YR economically and save more electricity of claims 1 and 2, the ‘turbo charger’ is glass beads.

12. A hybrid TCS-Siemens process for building a polysilicon plant of scale larger than 10,000 MT/YR economically and save more electricity of claims 1 and 2, the ‘turbo charger’ is zirconium powder.
